(19) United States
(12) Patent Application Publication
(10) Pub. No.: US 2023/0242373 A1
(43) Pub. Date: Aug. 3, 2023

(54) ELEVATOR SYSTEMS WITH IMPROVED MONITORING

(71) Applicant: Otis Elevator Company, Farmington, CT (US)

(72) Inventors: Uwe Schönauer, Berlin (DE); Peter Herkel, Berlin (DE); Felix Donath, Berlin (DE)

(21) Appl. No.: 17/973,671

(22) Filed: Oct. 26, 2022

(30) Foreign Application Priority Data
Jan. 28, 2022 (EP) 22154014.9

(51) Int. Cl. B66B 1/32; B66B 5/00; B66B 5/16

(52) U.S. Cl. CPC B66B 1/32; B66B 5/0031; B66B 5/16

(57) ABSTRACT

An elevator system (201) includes an elevator car (203) arranged to move within an elevator shaft, an elevator drive (211) including a brake (208), an elevator controller (230) configured to control the elevator drive so as to control the movement of the elevator car between a plurality of landings in the elevator shaft, a position reference system (240) configured to measure a position of the elevator car within the elevator shaft, and a safety controller (232) connected to the position reference system (240) to receive car position information and configured to selectively apply the brake of the elevator drive so as to stop the elevator car. The safety controller is configured to monitor the received car position information at least when the elevator car is moving in a designated unlocking zone of a given landing with an elevator car door open and to apply the brake.

### FOREIGN PRIORITY

This application claims priority to European Patent Application No. 22154014.9, filed Jan. 28, 2022, and all the benefits accruing therefrom under 35 U.S.C. § 119, the contents of which in its entirety are herein incorporated by reference.

### TECHNICAL FIELD

The present disclosure relates to elevator systems with improvements in monitoring when the elevator car is moving in a designated unlocking zone of a given landing with an elevator car door open, for example to reduce the occurrence of nuisance blockages.

### BACKGROUND

It is known for elevator systems to allow a re-levelling operation involving limited movement of the elevator car near a landing while the door is open, for example in response to a change in the elevator car load that alters the position of the elevator car floor relative to the adjacent landing floor or to deal with rollback arising from improper load weighing. However, elevator safety code or regulations typically require that the machine brake is applied if the elevator car leaves a designated re-levelling zone with doors not fully closed, i.e. an emergency stop. In addition, it may be required that a blockage is triggered. Once the machine brake has been applied in the case of a blockage, the elevator car is taken out of service until an authorized individual manually resets the controller to release the machine brake and allow the elevator car to resume normal operation.

It is desirable to improve monitoring of re-levelling operations and other movements of an elevator car with an elevator car door open so as to reduce unnecessary service downtime.

### SUMMARY

According to the present disclosure there is provided an elevator system comprising: an elevator car arranged to move within an elevator shaft; an elevator drive including a brake; an elevator controller configured to control the elevator drive so as to control the movement of the elevator car between a plurality of landings in the elevator shaft; a position reference system configured to measure a position of the elevator car within the elevator shaft; a safety controller connected to the position reference system to receive car position information and configured to selectively apply the brake of the elevator drive so as to stop the elevator car, wherein the safety controller is configured to monitor the received car position information at least when the elevator car is moving in a designated unlocking zone of a given landing with an elevator car door open and to apply the brake of the elevator drive upon determining from the received car position information that the position of the elevator car is outside a designated movement zone of the given landing, and wherein the safety controller is further configured to monitor the received car position information after the brake has been applied to stop the elevator car with an elevator car door open and to compare the position of the stopped elevator car to the designated unlocking zone of the given landing.

According to this disclosure, the safety controller monitors the received car position information both before and after the brake has been applied when the elevator car is moving with an elevator car door open. This means that the safety controller is able to make one or more decisions (e.g. safety-related decisions) even after the elevator car has left the designated movement zone. These one or more decisions may relate to a safety status, for example whether applying the brake is categorised as requiring a blockage or not. In some examples, the safety controller is further configured to make one or more decisions relating to a safety status after the elevator car has left the designated movement zone. These one or more decisions may relate to whether the brake is allowed to be released by the safety controller, for example if the position of the stopped elevator car is determined to be within the designated unlocking zone of the given landing. This takes into account a situation wherein the designated movement zone is smaller than the designated unlocking zone and hence it is considered safe to release the brake to allow a further operation of the stopped elevator car.

In one or more examples, when the safety controller determines that the position of the stopped elevator car is within the designated unlocking zone of the given landing, the brake is allowed to be released by the safety controller. In other words, the safety controller determines from the position of the stopped elevator car that a blockage is not necessary and the elevator car can be allowed to move again without requiring any intervention. This can enable further elevator movements with the elevator car door open, such as a levelling or re-levelling operation. In such examples, the safety controller is configured to release the brake. Following release of the brake, the elevator controller may be configured to control the movement of the elevator car to bring the elevator car back into the designated movement zone.

In one or more examples, when the safety controller determines that the position of the stopped elevator car is outside the designated unlocking zone of the given landing, the brake can only be released by an external intervention to reset the safety controller. In other words, the safety controller determines from the position of the stopped elevator car that a blockage is necessary and the elevator car can only be allowed to move again following an external intervention, e.g. a reset operation by an authorised person. The external intervention may take the form of a manual reset or override of the safety controller by an authorised external operator.

In one or more examples, the designated movement zone of the given landing is smaller than the designated unlocking zone of the given landing. In some examples, the designated movement zone is defined by a distance from the given landing of no more than ±100 mm, for example no more than ±50 mm, preferably no more than ±40 mm. In some typical examples, the designated unlocking zone is defined by a distance from the given landing of up to ±350 mm, for example up to ±300 mm, for example up to ±250 mm, preferably up to ±200 mm. The designated unlocking zone may be set by safety standards or code. In some elevator systems, the designated unlocking zone may be set by the sensitivity of the interlock mechanism between the car and landing doors. In some examples, the designated unlocking zone is defined by a smaller distance from the given landing than is typical, for example a distance of ±100 mm.

In one or more examples, the position reference system is configured to measure a relative position of the elevator car from the given landing. Various systems are known for measuring relative position, such as a landing alignment sensor (e.g. one or more “level sensors”) that is triggered when the elevator car floor is within a certain distance from the given landing. Another way of measuring a relative position of the elevator car from the given landing is using an encoder connected to a sheave which rotates when the elevator car moves. The encoder may be connected to a sheave of the elevator drive or to a pulley of a dedicated speed governor. Some examples are seen in WO 2015/119608, the contents of which are hereby incorporated by reference.

In examples wherein the position reference system is configured to measure a relative position of the elevator car from the given landing, the safety controller may be configured to apply the brake of the elevator drive upon determining that the relative car position exceeds a first threshold (e.g. indicating that the position of the elevator car is outside a designated re-levelling zone of a given landing) and to compare the relative car position of the stopped elevator car to a second threshold (e.g. indicating whether the elevator car remains within the designated unlocking zone of the given landing). The safety controller may only need to assess the relative car position against these two discrete thresholds.

In one or more examples, the position reference system is configured to measure an absolute position of the elevator car within the elevator shaft. Various systems are known for (e.g. continuously) measuring absolute position, typically comprising a position reference tape (such as a coded tape) extending at least part of the way along the elevator shaft (e.g. at least near the landings) and one or more sensors mounted on the elevator car and arranged to read the position reference tape to determine the absolute position of the elevator car within the elevator shaft. It is desirable for the position reference system to be configured to continuously measure an absolute position of the elevator car within the elevator shaft, as this assists the safety controller in continuously monitoring the received car position information after the brake has been applied during the car re-levelling operation. A continuous absolute position reference system may be more reliable for determining the position of the stopped elevator car in comparison to the designated unlocking zone, e.g. when deciding whether the elevator car has safely stopped within the designated unlocking zone but not reached the limit of the designated unlocking zone.

In some examples, the position reference system comprises one or more optical sensors mounted on the elevator car and arranged to read the position reference tape, e.g. a camera-based system. Such a system may comprise a series of optically readable markings, e.g. a code pattern, along the length of an elevator shaft, along with a camera arranged on the elevator car and configured to read the markings so as to enable determination of the absolute position of the elevator car within the shaft. The optical sensors may use visible light or infrared radiation.

In some examples, the position reference system comprises one or more magnetic sensors mounted on the elevator car and arranged to read the position reference tape, e.g. a magnetic-based system. Such a magnetic system may comprise a magnetic coded tape that runs along the length of the elevator shaft. The magnetic tape may be read, e.g. decoded, using at least one, e.g. a plurality of, Hall sensor(s) arranged on the elevator car, so as to determine the absolute position of the elevator car within the elevator shaft.

The position reference system may be additional to other systems provided for determining the position and/or speed of the elevator car within the elevator shaft during normal operation, for example an encoder arranged to monitor a sheave of the elevator drive. Such other systems may provide information directly to the elevator controller, whereas the position reference system communicates (e.g. directly) with the safety controller. Through its connection to the position reference system, the safety controller is able to reliably monitor the position of the elevator car when the elevator car is moving with an elevator car door open (e.g. during a re-levelling operation).

In the present disclosure, the elevator car may be moving in a designated unlocking zone of a given landing with an elevator car door open for a number of reasons. For example, the elevator car may be approaching the landing (e.g. with advance opening of the elevator car door) or undergoing a re-levelling operation to bring the floor of the elevator car into alignment with the floor of the landing after the elevator car has stopped at the landing. In a re-levelling operation, the position of the stopped elevator car is corrected during loading or unloading, if necessary by successive movements (automatic or inching).

When the elevator car is first stopped at the landing, the elevator car door may be (at least partially) opened in advance or only opened once the elevator car has come to a standstill. However, the stopped elevator car may not be positioned with the elevator car floor in exact alignment with the floor of the landing, for example due to a rollback arising from improper load weighing. During a car re-levelling operation there may be one or several movements of the elevator car with the elevator car door open in order to align the elevator car floor with the floor of the landing. In other examples, the elevator car may stop with the elevator car floor not in exact alignment with the floor of the landing due to an error in the motion profile upon approach to the landing, which can be corrected by a further controlled movement of the elevator car with the elevator car door open in order to fully align the elevator car floor with the floor of the landing.

In the present disclosure, what is meant by the elevator car moving with an elevator car door open is any movement of the elevator car with the elevator car door (and the associated landing door) not closed and locked. In other words, the elevator car door has been unlocked (e.g. by a door coupling device at the given landing) and is therefore openable. For example, the elevator car door may be unlocked and still closed. For example, the elevator car door may be unlocked and partially or fully open.

In the present disclosure, the designated movement zone of a given landing is defined by a set distance above/below the floor of the landing. The designated movement zone is where controlled movement of the elevator car with an open elevator car door is expected to take place.

In some examples, the designated movement zone of a given landing is a designated re-levelling zone in which re-levelling operations can take place. In some examples, the safety controller is configured to monitor the received car position information during an elevator car re-levelling operation.

The inventors have recognised that the designated movement zone of a given landing can be smaller than the unlocking zone of the landing. The designated unlocking zone of a given landing is defined by a distance above/below the floor of the landing in which the floor of the elevator car must be to enable the corresponding landing door(s) to be unlocked. In the designated unlocking zone there is permitted motion of the elevator car with the elevator car door(s) open (which means that the landing door(s) are also open). The inventors have recognised that the elevator car may be allowed to come to a stop with the elevator car door open within the designated unlocking zone, without requiring the safety controller to trigger a blockage.

According to typical elevator safety codes (such as EN81), movement of the elevator car with the landing and elevator car doors open is permitted (e.g. for levelling and re-levelling operations) on condition that the movement is limited to the designated unlocking zone and all movement of the elevator car outside the designated unlocking zone is prevented by a safety device (i.e. causing the safety controller to trigger a blockage).

In some examples, the safety controller is integrated with the elevator controller (i.e. two functions carried out by a common computer). For example, a single controller may be connected to the position reference system to receive car position information and configured to selectively apply the brake of the elevator drive so as to stop the elevator car.

In some examples, the safety controller is independent of the elevator controller. For example, the safety controller may be connected to the position reference system to receive car position information independently of the elevator controller. For example, the safety controller may be configured to selectively apply the brake of the elevator drive so as to stop the elevator car independently of the elevator controller.

In some examples, the safety controller is independent of the elevator controller by being dedicated to safety chain monitoring. In some examples, the safety controller is connected to at least one safety device in the elevator system, for example a safety device configured to detect a door open/closed state of the elevator car. As mentioned above, the elevator car door is considered open whenever it is not fully closed and locked.

In some examples, the safety controller is connected to a plurality of safety devices in a safety chain. The safety controller may communicate over a safety bus with the plurality of safety devices. Each of the safety devices may monitor an independent part of the elevator system. For example, each landing door may be provided with its own safety device configured to monitor the state of the landing doors, e.g. whether they are open or closed.

In some examples, the safety controller may comprise a PESSRAL node, e.g. a node defined as a Programmable Electronic System in Safety Related Applications for Lifts according to the relevant standard(s).

In some examples, the safety controller is configured to interrupt power to the elevator drive so as to apply the brake (e.g. by de-energising a relay to drop the brake). In various examples, the elevator drive may further include a drive motor and the safety controller may be configured to interrupt power to the drive motor (as well as applying the brake) so as to assist with stopping the elevator car.

According to a further aspect of the present disclosure, there is provided a method of monitoring an elevator car moving with an elevator car door open in an elevator system comprising an elevator car arranged to move between a plurality of landings in an elevator shaft, the method comprising: measuring a position of the elevator car within the elevator shaft; monitoring the position of the elevator car at least when the elevator car is moving in a designated unlocking zone of a given landing with an elevator car door open and applying a brake to the elevator car upon determining that the position of the elevator car moving with an elevator car door open is outside a designated movement zone of the given landing; and further monitoring the position of the elevator car after the brake has been applied to stop the elevator car with an elevator car door open and comparing the position of the stopped elevator car to the designated unlocking zone of the given landing.

In some examples, the method further comprises making one or more decisions relating to a safety status after the elevator car has left the designated movement zone.

In some examples, the method further comprises: allowing the brake to be released upon determining that the position of the stopped elevator car is within the designated unlocking zone of the given landing.

In some examples, the method further comprises: preventing the brake from being released, without an external intervention, upon determining that the position of the stopped elevator car is outside the designated unlocking zone of the given landing. For example, the required external intervention may be a manual reset of a safety controller configured to carry out the steps of the method disclosed herein.

In various examples, the steps of the method disclosed herein for monitoring an elevator car moving with an elevator car door open are carried out by a safety controller, e.g. a safety controller acting independently of an elevator controller. In such examples, the elevator controller is configured to control an elevator drive so as to control the movements of the elevator car in the elevator shaft (including movements of the elevator car moving an elevator car door open, e.g. during a car re-levelling operation). This means that the monitoring provided by the safety controller is independent of the elevator controller that actually controls movement of the elevator car.

### BRIEF DESCRIPTION OF THE DRAWINGS

Certain examples of the present disclosure will now be described with reference to the accompanying drawings, in which:

FIG. 1 is a schematic illustration of a typical elevator system that may employ examples of the present disclosure;

FIG. 2 is a schematic illustration of an elevator system according to an example of the present disclosure;

FIG. 3 is a schematic illustration of an elevator car position relative to a given landing for an elevator car moving with an elevator car door open in an example wherein: (a) the brake can be released; and (b) a blockage is required;

FIG. 4 is a flow chart illustrating a method of monitoring an elevator car moving with an elevator car door open according to an example of the present disclosure.

### DETAILED DESCRIPTION

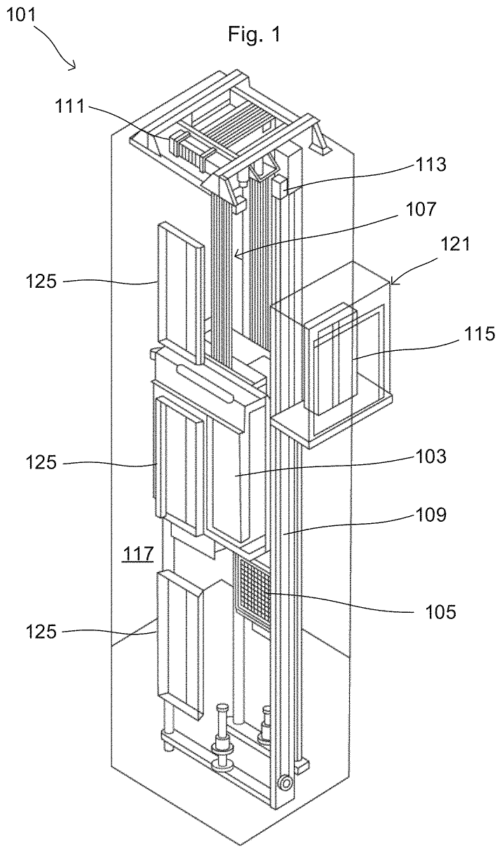

FIG. 1 is a perspective view of an elevator system 101 including an elevator car 103, a counterweight 105, a tension member 107, a guide rail 109, an elevator drive 111, an encoder 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the elevator drive 111, which is part of an overhead structure of the elevator system 101. The elevator drive 111 is configured to control movement between the elevator car 103 and the counterweight 105, and thus control the position of the elevator car 103 within the elevator shaft 117. The encoder 113 may be mounted on a fixed part at the top of the elevator shaft 117, such as on a support or guide rail, and may be configured to provide position signals related to a relative position of the elevator car 103 within the elevator shaft 117. The encoder 113 is typically connected to the controller 115 so that the controller 115 can monitor the speed and motion profile of the elevator car 103 as it is driven to move between one or more landings 125 in the elevator shaft 117.

The controller 115 is shown as located in a controller room 121 of the elevator shaft 117 and is configured to control the operation of the elevator car 103. For example, the controller 115 may provide drive signals to the elevator drive 111 to control the acceleration, deceleration, levelling, stopping, re-levelling, etc. of the elevator car 103. The controller 115 may also be configured to receive position signals from the encoder 113 or any other desired position reference system. When moving up or down within the elevator shaft 117 along the guide rail 109, the elevator car 103 may stop at the one or more landings 125 as controlled by the controller 115. Although shown in a controller room 121, those of skill in the art will appreciate that the controller 115 can be located and/or configured in other locations or positions within the elevator system 101. For example, the controller may be located remotely or in the cloud.

The elevator drive 111 may include a motor or similar driving mechanism, and a brake. The elevator drive 111 may be configured to include an electrically driven motor and an electrically released brake. The power supply for the motor and/or brake may be any power source, including a power grid, which, in combination with other components, is supplied to the elevator drive 111. The elevator drive 111 may include a traction sheave, moved by the motor, that imparts force to tension member 107 to move the elevator car 103 within elevator shaft 117.

Although shown and described with a roping system including a tension member 107, elevator systems that employ other methods and mechanisms of moving an elevator car within an elevator shaft may employ examples of the present disclosure, with the tension member 107 being omitted. For example, ropeless elevator systems may use a linear motor or a hydraulic device to directly drive movement of the elevator car 103. FIG. 1 is merely a non-limiting example presented for illustrative and explanatory purposes. Features of the elevator system 101 may be applied to the elevator system described in more detail below.

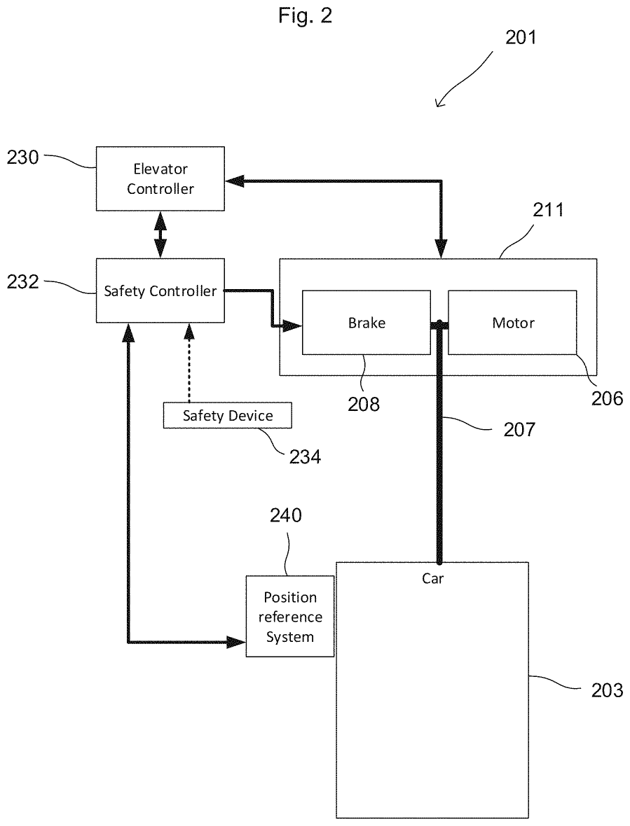

FIG. 2 is a schematic illustration of an elevator system 201 in accordance with an example of the present disclosure. As shown, the elevator system 201 comprises an elevator car 203 which is movable in an elevator shaft between a plurality of landings. The elevator car 203 is suspended by a tension member 207 which is driven by an elevator drive 211. The elevator drive 211 is thus configured to move the elevator car 203, via the tension member 207, in the elevator shaft.

The elevator drive 211 includes a motor 206 and a brake 208, e.g. in the form of a machine brake arranged to act directly on the motor 206 (or its associated traction sheave) such that when the brake 208 is applied movement of the motor 206 is stopped, and consequently the elevator car 203 is stopped from moving within the elevator shaft.

The elevator system 201 comprises an elevator controller 230 and a safety controller 232. The elevator controller 230 is operatively connected to the elevator drive 211 to control movement of the elevator car 203 within the elevator shaft. The safety controller 232 is operatively connected to the elevator drive 211, independently of the elevator controller 230, so as to control the brake 208. There is also shown an exemplary safety device 234 operatively coupled to the safety controller 232. The safety device 234 may monitor a part of the elevator system, for example a sensor to detect the opening of the door(s) of the elevator car 203. Whilst the safety device 234 is illustrated as a single safety device 234, it may comprise a plurality of safety devices in a safety chain, for example limit switches, landing door sensors, load sensors, speed sensors, emergency stop buttons, etc.

The elevator system 201 further comprises a dedicated position reference system 240. The position reference system 240 may be mounted to the elevator car 203, as shown, or mounted elsewhere in the elevator shaft. The position reference system 240 may be any suitable system that is capable of determining a relative or absolute position of the elevator car 203 within the elevator shaft. The position reference system 240 is in direct communication with the safety controller 232 in this example. Although not shown, the position reference system 240 may optionally be in communication with the elevator controller 230 as well.

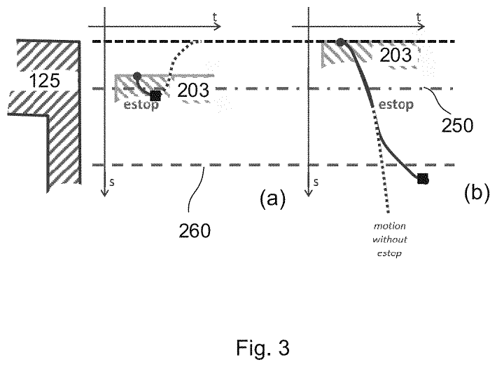

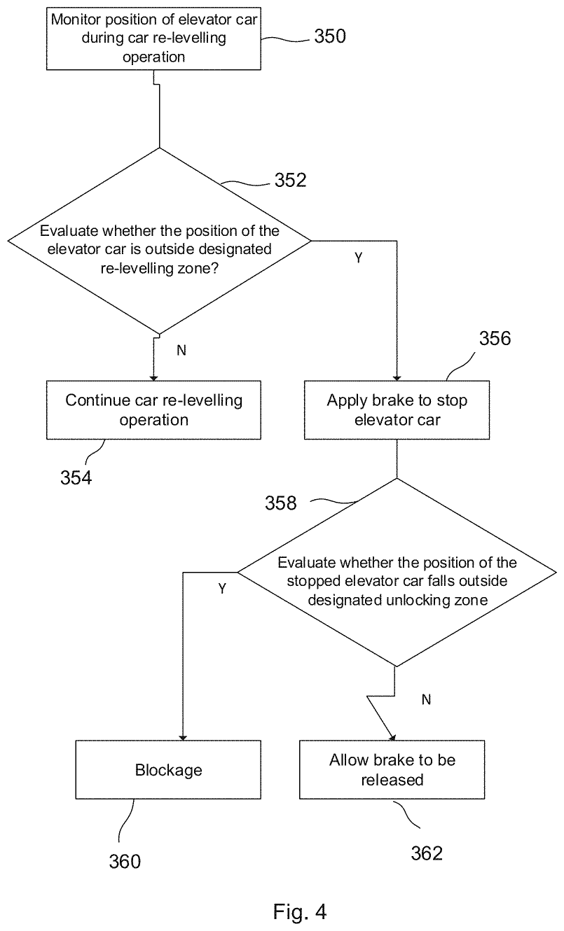

Operation of the elevator system 201 will now be described with reference to FIGS. 2 and 3, and the flow diagram of FIG. 4.

When the elevator car 203 is moving in the vicinity of a landing 125 with an elevator car door open, e.g. during a re-levelling operation of the elevator car 203 to bring the floor of the elevator car 203 into alignment with the floor of a given landing, the safety controller 232 is configured to monitor the car position information received from the position reference system 240. FIG. 3 shows the motion profile of an elevator car 203 as an overlaid plot of speed (s) versus time (t) when the elevator car 203 is moving in the vicinity of a landing 125 with an elevator car door open. As understood with reference to FIG. 3, the safety controller 232 monitors the received car position information to evaluate whether the elevator car 203 leaves the designated movement (e.g. re-levelling) zone 250 and the brake 208 needs to be applied. After the brake 208 has been applied in an “estop”, the safety controller 232 continues to monitor the received car position information to evaluate whether the elevator car 203 remains within the designated unlocking zone 260. The safety controller 232 compares the position of the stopped elevator car (denoted by a square) to the designated unlocking zone 260.

Based on this evaluation, the safety controller 232 can make a decision about whether the stopped elevator car has an unsafe status requiring a blockage (e.g. outside the designated unlocking zone 260 with an elevator car door open), as seen in FIG. 3(b), or a safe status (e.g. inside the designated unlocking zone 260 with an elevator car door open), as seen in FIG. 3(a). When a safe status is determined, the safety controller 232 can allow the brake 208 to be released for the elevator controller 230 to move the elevator car 203 again, e.g. to attempt another re-levelling operation (as shown by the dotted line). In the example seen in FIG. 3(a), this allows the re-levelling operation to recover without requiring a callout for external intervention.

This further monitoring of the position of the stopped elevator car and comparison to the designated unlocking zone 260 can prevent unnecessary (i.e. “nuisance”) blockages from occurring. This approach is also helpful for elevator systems having an increased blockage sensitivity, e.g. due to a relatively small designated movement zone 250, such as only ±40 mm from the landing 125. For example, if a glitch in the safety chain causes the safety controller 232 to apply the brake 208 (i.e. an “estop” when the elevator car 203 is just 2 mm inside the designated movement zone 250 and the subsequent relevel run has a 3 mm roll-back, then a blockage would be triggered without the further monitoring seen in FIG. 3a. The monitoring system and method described herein therefore allows movement of the elevator car to be recovered without an external intervention.

Some steps of this exemplary method are illustrated in FIG. 4. At step 350, the safety controller 232 uses car position information received from the position reference system 240 to monitor the position of the elevator car 203 throughout a car re-levelling operation. At step 352, the safety controller 232 evaluates whether the position of the elevator car 203 is outside the designated re-levelling zone 250. The car re-levelling operation can continue as long as the elevator car 203 remains within the designated re-levelling zone 250, as shown at step 354. When the elevator car 203 is outside the designated re-levelling zone 250, the safety controller 232 applies the brake 208 to stop the elevator car 203 at step 356.

Unlike conventional systems, the safety controller 232 continues to monitor the position of the elevator car 203 even after the brake 208 has been applied and the elevator car is coming to a standstill. At step 358, the safety controller 232 evaluates whether the position of the stopped elevator car falls outside the designated unlocking zone 260. If the stopped position of the elevator car 203 is outside the designated unlocking zone 260 then the safety controller 232 registers a blockage, as shown at step 360. This corresponds to FIG. 3(b). However, if the stopped position of the elevator car 203 is within the designated unlocking zone 260 then the safety controller 232 can allow the brake 208 to be released, as shown at step 362. This corresponds to FIG. 3(a), wherein a nuisance blockage is avoided.

What is claimed is:

1. An elevator system (201) comprising:
an elevator car (203) arranged to move within an elevator shaft (117);
an elevator drive (211) including a brake (208);
an elevator controller (230) configured to control the elevator drive (211) so as to control the movement of the elevator car (203) between a plurality of landings (125) in the elevator shaft (117);
a position reference system (240) configured to measure a position of the elevator car (203) within the elevator shaft (117);
a safety controller (232) connected to the position reference system (240) to receive car position information and configured to selectively apply the brake (208) of the elevator drive (211) so as to stop the elevator car (203),
wherein the safety controller (232) is configured to monitor the received car position information at least when the elevator car (203) is moving in a designated unlocking zone (260) of a given landing (125) with an elevator car door open and to apply the brake (208) of the elevator drive (211) upon determining from the received car position information that the position of the elevator car (203) is outside a designated movement zone (250) of the given landing (125), and
wherein the safety controller (232) is further configured to monitor the received car position information after the brake (208) has been applied to stop the elevator car (203) with an elevator car door open and to compare the position of the stopped elevator car to the designated unlocking zone (260) of the given landing (125).

2. The elevator system of claim 1, wherein the safety controller (232) is further configured to make one or more decisions relating to a safety status after the elevator car (203) has left the designated movement zone (250).

3. The elevator system of claim 1, wherein, when the safety controller (232) determines that the position of the stopped elevator car is within the designated unlocking zone (260) of the given landing, the brake (208) is allowed to be released by the safety controller (232).

4. The elevator system of claim 1, wherein, when the safety controller (232) determines that the position of the stopped elevator car is outside the designated unlocking zone (260) of the given landing, the brake (208) can only be released by an external intervention to reset the safety controller (232).

5. The elevator system of claim 1, wherein the designated movement zone (250) of the given landing (125) is smaller than the designated unlocking zone (260) of the given landing.

6. The elevator system of claim 1, wherein the safety controller (232) is configured to monitor the received car position information during an elevator car re-levelling operation.

7. The elevator system of claim 1, wherein the position reference system (240) is configured to measure a relative position of the elevator car (203) from the given landing.

8. The elevator system of claim 1, wherein the position reference system (240) is configured to continuously measure an absolute position of the elevator car within the elevator shaft.

9. The elevator system of claim 1, wherein the safety controller (232) is connected to a plurality of safety devices (234) in a safety chain.

10. A method of monitoring an elevator car (203) moving with an elevator car door open in an elevator system (201) comprising an elevator car arranged to move between a plurality of landings (125) in an elevator shaft (117), the method comprising:
measuring a position of the elevator car (203) within the elevator shaft;
monitoring the position of the elevator car (203) at least when the elevator car is moving in a designated unlocking zone (260) of a given landing (125) with an elevator car door open and applying a brake (208) to the elevator car (203) upon determining that the position of the elevator car moving with an elevator car door open is outside a designated movement zone (250) of the given landing; and
further monitoring the position of the elevator car (203) after the brake (208) has been applied to stop the elevator car with an elevator car door open and comparing the position of the stopped elevator car to the designated unlocking zone (260) of the given landing.

11. The method of claim 10, further comprising:
making one or more decisions relating to a safety status after the elevator car (203) has left the designated movement zone (250).

12. The elevator system of claim 10, further comprising:
allowing the brake (208) to be released upon determining that the position of the stopped elevator car is within the designated unlocking zone (260) of the given landing.

13. The elevator system of claim 10, further comprising:
preventing the brake (208) from being released, without an external intervention, upon determining that the position of the stopped elevator car is outside the designated unlocking zone (260) of the given landing.
